(19) United States
(12) Patent Application Publication
(10) Pub. No.: US 2008/0046375 A1
(43) Pub. Date: Feb. 21, 2008

(54) Method and System for Distributing Digital Works

(75) Inventor: Frank J. Jakubaitis, Tustin Ranch, CA (US)

Correspondence Address: HUNTON & WILLIAMS LLP;INTELLECTUAL PROPERTY DEPARTMENT, RIVERFRONT PLAZA, EAST TOWER, 951 EAST BYRD ST., RICHMOND, VA, 23219-4074, US

(73) Assignee: e2interactive, Inc. d/b/a e2Interactive, Inc., Atlanta, GA (US)

(21) Appl. No.: 11/930,639

(22) Filed: Oct. 31, 2007

Related U.S. Application Data
(63) Continuation of application No. 09/607,202, filed on Jun. 28, 2000.
(60) Provisional application No. 60/140,929, filed on Jun. 28, 1999.

(51) Int. Cl. H04L 9/00

(52) U.S. Cl. 705/51

(57) ABSTRACT

Systems and methods for distributing digital works are described, comprising an indicia redeemable for a desired digital work(s), a customer node, and a remote server. The remote server and the customer node are intermittently coupled through a communications link. The digital work(s) and associated identification data are stored at the remote server. The customer obtains the indicia redeemable for a digital work(s), connects from the customer node to the remote server, and sends a request to redeem the indicia and to access desired digital work(s). The remote server receives the request and searches the digital works stored on the remote server for the desired digital work(s) specified in the received request. If the desired digital work(s) is found, it is transmitted from the remote server to the customer node and stored on a memory of the customer node for subsequent access and use.

### RELATED APPLICATIONS

This application is a continuation of, and claims priority to, U.S. patent application Ser. No. 09/607,202 filed on Jun. 28, 2000, which in turn claims the benefit of U.S. Provisional Application No. 60/140,929, entitled “NetPack Special Application Package” and filed Jun. 28, 1999. Both of these applications are incorporated herein by reference in their entirety.

### BACKGROUND

This invention relates to methods and systems for distributing digital works, and in particular embodiments, methods and systems for distributing digital works among a retail merchant at a merchant node, a remote server, and a customer at a customer node through a public communications network.

The Internet is a worldwide system of computer networks which allows users at any one computer to exchange computer data with users at any other computer. The World Wide Web (“WWW”) is the most widely used part of the Internet. The WWW is based on the exchange of information between server and client computers. Each server computer has software, called a web server, and each client computer has software, called a web browser, for exchanging information over the WWW. One or more server computers store graphical pages of information, called web pages, which make up a web site. The WWW allows the server computer to send web pages to a user's client computer and allows the client computer to display the web pages. The web pages may contain certain words or phrases, buttons, or images which are “clickable” and allow the user to request and display related web pages of information in a hypertext fashion.

In recent years, the buying and selling of goods and services on the WWW, otherwise known as electronic commerce or e-commerce, has greatly increased in popularity. One problem with conducting e-commerce on the WWW is that it requires the customer to shop, sitting down in front of a computer and-using an Internet connection. However, most customers still prefer to conduct their shopping at traditional retail merchants where computers and Internet connections are not readily available for use by all customers. Therefore, e-commerce companies are unable to offer their products and services for sale in a traditional retail environment. Additionally, there is still some customer concern about performing financial transactions, such as using credit card numbers, over the WWW to purchase products and services.

Accordingly, it would be desireable to develop a method and a system for distributing digital works which allows consumers to purchase Internet-based products and services at traditional retail merchants without the need of a computer or Internet connection at the time of purchase.

### BRIEF DESCRIPTION OF THE DRAWINGS

A detailed description of embodiments of the invention will be made with reference to the accompanying drawings, wherein like numerals designate corresponding parts in the several figures.

FIG. 1 is a block diagram illustrating a system for distributing digital works in accordance with an embodiment of the present invention.

FIGS. 2A and 2B illustrate a sample package associated with a digital work which is available for purchase at a retail merchant in accordance with an embodiment of the present invention.

FIGS. 3A and 3B illustrate another sample package associated with a digital work which is available for purchase at a retail merchant in accordance with another embodiment of the present invention.

FIG. 4 illustrates a sample web page for downloading a digital work from a remote server through a public communications network to a customer node in accordance with an embodiment of the present invention.

### DETAILED DESCRIPTION OF THE INVENTION

As shown in the drawings for purposes of illustration, embodiments of the present invention include a method and a system for distributing digital works among a retail merchant at a merchant node, a remote server, and a customer at a customer node through a public communications network, preferably the Internet. In some embodiments of the present invention, the method utilizes and the system includes one or more digital works. Each digital work includes a text, audio, video, or multimedia work which has been translated to or created in a digital form and which can be recreated or accessed using suitable interpreters, such as software programs. The digital work may be a book, a periodical subscription (such as a newspaper or magazine), a song or collection of songs, a movie, a software program, or the like.

In some embodiments, each digital work is presented in a package which is available for purchase at a retail merchant, such as a convenience store, a gasoline station, a supermarket, an office supply outlet, a mall kiosk, or the like. After purchasing the package, the customer downloads the digital work from a remote server through the Internet to a customer node.

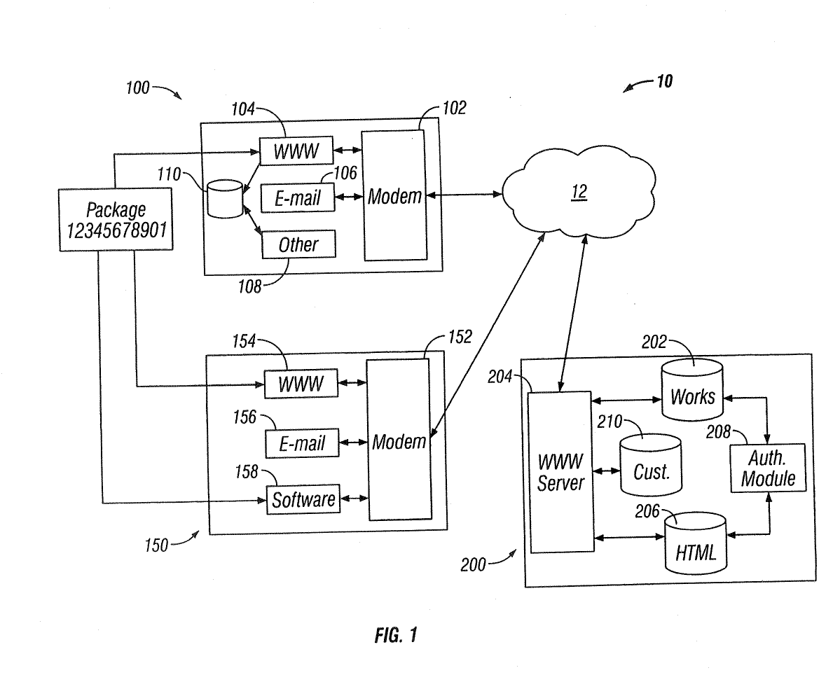

FIG. 1 illustrates the operational environment for the method and the basic components of the system 10 in accordance with embodiments of the present invention. In some embodiments, the system 10 includes a communications link, which in turn includes a public communications network 12, preferably the Internet 12. The communications link is connected to and serves as a medium of communication among a customer node 100, a merchant node 150, and a remote server 200. The communications link includes the Internet 12 as well as equipment for connecting the customer node 100, the merchant node 150, and the remote server 200 in a manner well known to those skilled in the art. In alternative embodiments, the communications link may include any other public or hybrid public-private communications network which transfers data packets among computers or nodes in the network.

In the embodiment illustrated in FIG. 1, the system 10 includes a customer node 100. In some embodiments, the customer node 100 is a conventional computer equipped with memory (such as RAM, ROM, and a hard disk), at least one processor, an input device (such as a keyboard, a mouse or other pointing device, and/or the like), and an output device (such as a display or the like). The customer node 100 also includes communications equipment for connecting to the Internet 12, such as a modem 102, and connects to the Internet 12 via a public or private connection using such equipment. As is well known in the art, the customer node 100 may connect to the Internet 12 via a wire line (such as twisted-pair telephone wire, coaxial cable, electric power line, optical fiber wire, leased line, or the like) or wireless (such as satellite, cellular, radio frequency, or the like) connection using the modem 102. A customer using the customer node 100 may obtain access to the Internet 12 using an online services network (such as America Online, CompuServe, Microsoft Network, Prodigy, or the like) or by establishing an account with an Internet Service Provider (ISP). In alternative embodiments, the customer node 100 may include other equipment for connecting to the Internet 12, such as a network card or the like, and may connect to the Internet 12 via other connections, such as a private enterprise network (e.g., LAN) which includes at least one server connected to the Internet 12 or the like. In some embodiments, the customer node 100 further includes a web browser 104 stored on the memory of the customer node 100, such as Microsoft.RTM. Internet Explorer developed by Microsoft Corporation or Netscape.RTM. Navigator developed by Netscape, Inc., which allows the customer to request, retrieve, and view web pages. The customer node 100 may also include an email program 106 and/or other applications 108 (such as a word processing program, a spreadsheet program, or the like) stored on the memory of the customer node 100. In alternative embodiments, the customer node 100 may be other types of systems with similar equipment and components, such as a pen-based system, a kiosk, or the like.

In the illustrated embodiment, the system 10 also includes a merchant node 150. In some embodiments, the merchant node 150 is a conventional computer equipped with memory (such as RAM, ROM, and a hard disk), at least one processor, an input device, an output device, and communications equipment for connecting to the Internet 12 (such as a modem 152). The merchant node 150 may also include a web browser 154, an e-mail program 156, and/or other applications (not shown) stored on the memory of the merchant node 150. These components may be identical to the components described with respect to the customer node 100 illustrated in FIG. 1. The merchant node 150 may connect to, and a retail merchant using the merchant node 150 may obtain access to, the Internet 12 in a manner similar to the manner described above with respect to the customer node 100. In some embodiments, the merchant node 150 further includes a validation software program 158, such as Verifone's magnetic card reader software (e.g., as found in its card readers) for connecting to the Internet 12 or other public communications network and updating a database of digital works 202 stored on the remote server 200, as more fully described below. In alternative embodiments, the merchant node 150 may be other types of systems with similar equipment and components, such as a pen-based system, a kiosk, or the like.

In the embodiment illustrated in FIG. 1, the system 10 further includes a remote server 200 which provides a remote web site 200 on the WWW. In some embodiments, the remote server 200 is a conventional computer with memory (such as RAM, ROM, and a hard disk) and at least one processor. The remote server 200 is connected to the Internet 12, either directly or via a network such as a local area network (“LAN”), a wide area network (“WAN”), or the like. The remote server 200 includes a database of one or more digital works 202 stored on the memory of the remote server 200. Each digital work 202 is preferably stored as a self-contained module of compressed software and/or data. Some digital works 202, such as a book, may simply include basic files (such as a word processing document, a text file, or the like) which may be viewed using an application 108 (such as a word processing program, Adobe.RTM. Acrobat.RTM. Reader, or the like) already installed on the customer node 100. Other digital works 202, such as a software program, may include files comprising the software program itself as well as setup or installation executable files for installing the software program on the customer node 100. The database also includes identification data associated with each digital work 202, such as a unique identifier, a unique combination of a user name and a password, or the like.

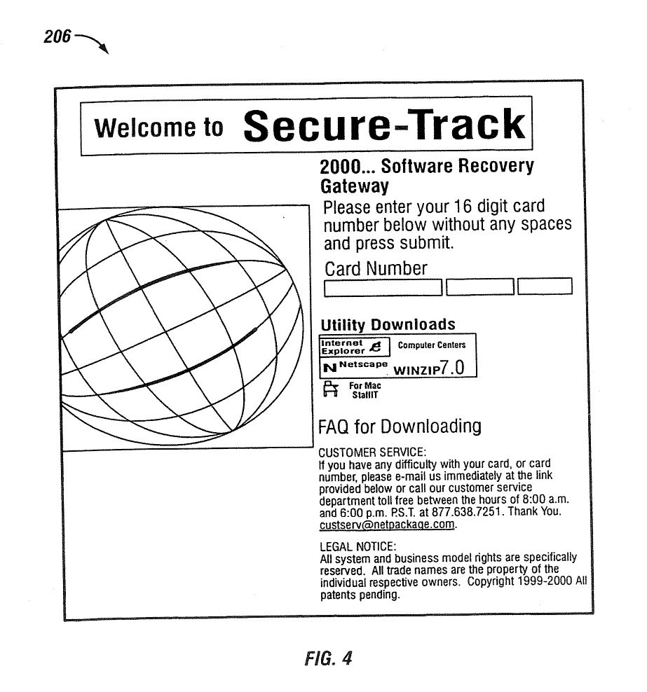

The remote server 200 further includes a web server 204 which communicates with the web browser 104 executing on the customer node 100 and/or the web browser 154 executing on the merchant node 150 using standard communications protocols, such as HyperText Transfer Protocol (“HTTP”) or the like, to display desired web pages of the remote web site 200. The web server 204 accesses one or more HTML documents 206 which are stored on the remote server 200 and which can be requested, retrieved, and viewed by the customer at the customer node 100 via the web browser 104 and/or the retail merchant at the merchant node 150 via the web browser 154. The HTML documents 206 include an interface for downloading one or more digital works 202 stored on the memory of the remote server 200, as shown in FIG. 4.

In the illustrated embodiment, the system 10 also includes a package associated with each digital work 202 which is available for purchase at a retail merchant. As described more fully below, the package includes the identification data associated with each digital work 202, information about the digital work 202, and instructions for downloading the digital work 202. After purchasing the package, the customer downloads the digital work 202 from the remote server 200 through the public communications network 12 to the customer node 100.

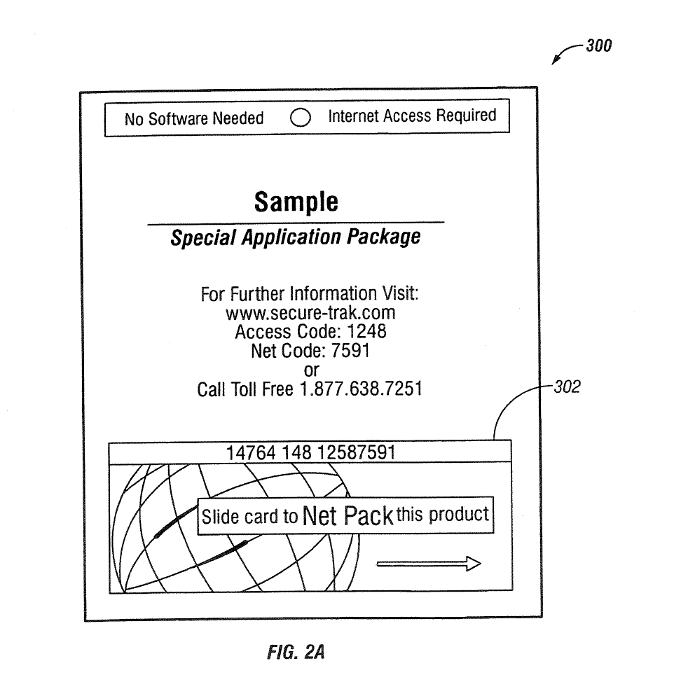

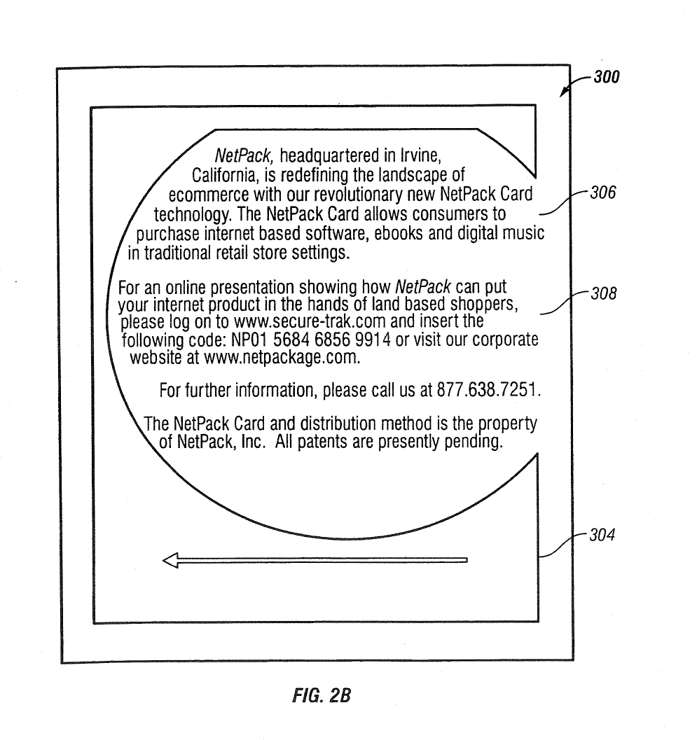

A method for distributing digital works 202 among the retail merchant at the merchant node 150, the remote server 200, and the customer at the customer node 100 through the public communications network 12, preferably the Internet, shown in FIG. 1 will now be described with reference to FIGS. 1-4. FIGS. 2A and 2B illustrate a sample package 300 as available for purchase by the customer at the retail merchant. In the illustrated embodiment, the package 300 includes identification data 302 displayed on the package 300. In one embodiment, the identification data 302 is a unique 16-character alphanumeric identifier 302. However, in alternative embodiments, the identification data 302 may be other types of data, such as a user name and/or password, may be other forms of identifiers, such as alphabetic-only or numeric-only identifiers, and may include any number of characters. In the illustrated embodiment, the package 300 also includes a magnetic strip 304 on the package 300. In alternative embodiments, the magnetic strip 304 may be omitted. The package 300 further includes information 306 about the digital work 202, such as pictures and a brief summary of the digital work 202, displayed on the package 300. Moreover, the package 300 includes instructions 308 for downloading the digital work 202 and specifies the universal resource locator address for the remote server web site 200 from which the digital work 202 is available for downloading.

In one embodiment, the customer simply purchases the package 300 associated with a desired one of the digital works 202 at the retail merchant and then downloads the desired digital work 202 from the remote server 200. No further action, such as reading the identifier 302 from the package 300 or activating or validating the package 300, is required by either the customer or the retail merchant.

In alternative embodiments, the package 300 may require activation or validation by the retail merchant. Although the identifier 302 is displayed on the outer surface of the package 300, the desired digital work 202 is not available for access or download from the remote server 200 until such activation or validation. The retail merchant inputs the identifier 302 into the merchant node 150 using a standard input device, such as typing the identifier 302 using a keyboard, scanning the identifier 302 with a bar code scanner, reading the identifier 302 from the magnetic strip 304 using a magnetic card reader, or the like. Once the identifier 302 is input into the merchant node 150, the validation software program 158 connects to the public communications network 12 using the modem 152 and sends through the public communications network 12 to the remote server 200 a request to set the status of the desired digital work 202 as available for access, specifying the identifier 302 of the desired digital work 202 included in the purchased package 300. When the remote server 200 receives this request, the database of digital works 202 is searched for the desired digital work 202 identified by the identifier 302 included in the received request, and the status of the desired digital work 202 is set as available for access.

In other alternative embodiments, the package 300 may require reading a portion or all of the identifier 302 from the package 300 in order to provide the identifier 302 to the customer. In the embodiment illustrated in FIGS. 2A and 2B, the entire identifier 302 is displayed on an outer surface of the package 300. However, in other alternative embodiments of the present invention, only a portion or none of the identifier 302 is displayed on the outer surface of the package 300. At the retail merchant, the non-displayed portion of the identifier 302 is read from the magnetic strip 304 on the package 300 and then printed on a receipt which is given to the customer. Thus, the identifier 302 includes the first portion (if any) of the identifier 302 displayed on the outer surface of the package 300 and the second portion of the identifier 302 read from the magnetic strip 304 on the package 300 and printed on the customer's receipt.

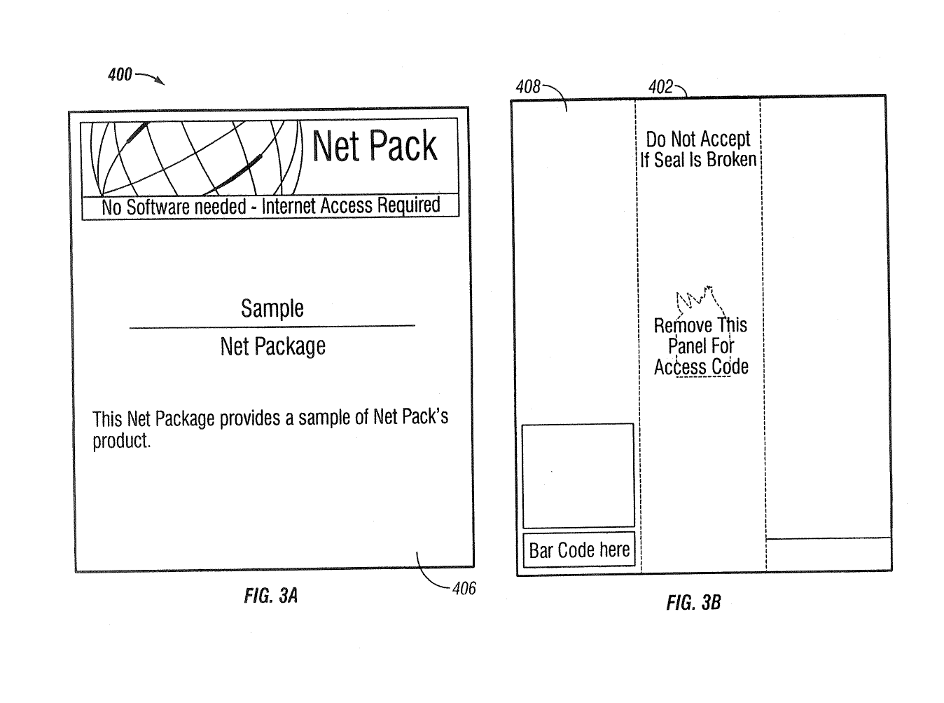

FIGS. 3A and 3B illustrate another sample package 400 as available for purchase by the customer at the retail merchant. In the illustrated embodiment, the package 400 includes similar elements to the package 300 shown in FIGS. 2A and 2B. The package 400 includes information 406 about the digital work 202, such as pictures and/or a brief summary of the digital work 202, displayed on the package 400. The package 400 may be opened and include multiple pages of information about the digital work 202 (not shown). The package 400 also includes instructions 408 for downloading the digital work 202 and specifies the universal resource locator address for the remote server web site 200 from which the digital work 202 is available for downloading. As shown, the package 400 further includes identification data disposed on an inside surface of the package 400 and sealed within the package 400 behind a tamper proof, removable panel 402. In one embodiment, the identification data is a unique combination of a user name and password. However, in alternative embodiments, the identification data may be other types of data, such as an alphabetic, numeric, or alphanumeric identifier. In other alternative embodiments, a first portion of the identification data may be displayed on the outer surface of the package 400, and a second portion of the identification data may be disposed on the inside surface of the package 400 and sealed within the package 400 behind the removable panel 402. In further alternative embodiments, the package 400 may also include a magnetic strip (not shown) on the package 400, and a first portion of the identification data may be stored on and read from the magnetic strip, and a second portion of the identification data may be disposed on the inside surface of the package 400 and sealed within the package 400 behind the removable panel 402.

In some embodiments, once the customer purchases the package 300 or 400 associated with a desired one of the digital works 202 at the retail merchant, the customer then accesses the remote web site 200 via the web browser 104 on the customer node 100. The customer node 100 sends through the public communications network 12 to the remote server 200 a request for the home page 206 of the remote web site 200. When the remote server 200 receives this request, the web server 204 on the remote server 200 retrieves the home page 206 of the remote web site 200 and sends the requested home page 206 to the customer node 100 through the public communications network 12. The home page 206 is then displayed to the customer at the customer node 100 via the web browser 104, as shown in FIG. 4. In the illustrated embodiment, the home page 206 provides an interface for downloading the desired digital work 202 from the remote server 200 through the public communications network 12 to the customer node 10. The customer inputs the identifier 302 or 402 for the desired digital work using a standard input device, such as typing the identifier 302 using a keyboard or reading the identifier 302 from the magnetic strip 304 using a magnetic card reader, and then clicks the “Submit” button. The customer node 100 sends through the public communications network 12 to the remote server 200 a request for the desired digital work 202, specifying the identifier 302 or 402 of the desired digital work 202 included in the purchased package 300 or 400. When the remote server 200 receives this request, an authorization module 208 on the remote server 200 searches the database of digital works 202 for the desired digital work 202 specified by the identifier 302 or 402 included in the received request. If the desired digital work 202 is found, it is transmitted (i.e., downloaded) from the remote server 200 through the public communications network 12 to the customer node 100. When the desired digital work 202 is received at the customer node 100, it is stored on the memory of the customer node 100 for subsequent access and use by the customer. If the desired digital work 202 is not found, an error message is transmitted from the remote server 200 through the public communications network 12 to the customer node 100, indicating that the desired digital work 202 was not found or not available on the remote server 200.

In some embodiments, before or after the desired digital work 202 is downloaded from the remote server 200, the remote server 200 sends a request for customer registration data through the public communications network 12 to the customer node 100. An HTML document 206 is displayed at the customer node 100, asking the customer to enter demographic information (such as the customer's name, address, phone number(s), e-mail address, age, sex, marital status, number of children, occupation, income, and interests). This information is then sent to the remote server 200 and stored in a customer database 210 on the memory of the remote server 200. The information stored in the customer database 210 may then be used to market other digital works 202 and/or other related products and services to registered customers.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for distributing digital works among a retail merchant, a remote server, and a customer at a customer node, the remote server being intermittently coupled to the customer node, that method comprising the steps of:
storing the digital works and their associated identification data on a memory of the remote server;
providing from the retail merchant to the customer an indicia redeemable for one or more of the digital works;
receiving at the remote server a request to redeem the indicia;
receiving at the remote server a distribution request, the distribution request comprising an identification of a desired digital work from the one or more digital works;
transmitting the desired digital work from the remote server to the customer node;
receiving at the customer node the desired digital work;
storing the desired digital work on a memory of the customer node.

2. The method of claim 1, wherein the identification of the desired digital work comprises a unique identifier.

3. The method of claim 2, wherein the desired digital work is associated with a unique identifier, and the unique identifier is stored in the remote server.

4. The method of claim 3, wherein the remote server is intermittently coupled to a merchant node used by the retail merchant, and wherein the remote server further comprises a status indicator indicating whether the indicia is available or not available for redemption, the method further comprising the steps of:
receiving a redemption request of the indicia, the redemption request specifying the unique indicia; and
setting at the remote server the status of the indicia as available for redemption.

5. The method of claim 3, wherein the indicia redeemable for one or more digital works stored on the remote server comprises a unique combination of an identifier and a password, and wherein the unique combination of the identifier and the password are disposed on a package.

6. The method of claim 5, wherein the password is a personal identification number (PIN).

7. The method of claim 5, wherein the password is obscured from view at the time of purchase.

8. The method of claim 1, further comprising the steps of:
sending a request for customer registration data from the remote server through the public communications network to the customer node;
inputting at the customer node the request customer registration data;
transmitting the inputted customer registration data from the customer node through the public communications network to the remote server;
receiving at the remote server the transmitted customer registration data; and storing the transmitted customer registration data on the memory of the remote server.

9. The method of claim 1, wherein the remote server is intermittently coupled to the customer node over a public communications network.

10. The method of claim 9, wherein the public communications network comprises the Internet.

11. A system for distributing one or more digital works, the system comprising;
a. an indicia redeemable for one or more digital works, wherein the indicia is obtained from a retail merchant;
b. a customer node used by a customer, the a customer node comprising;
i. memory;
ii. a processor connected to the memory of the customer node; and
iii. equipment connected to the processor of the customer node for coupling to a communications link; and
iv. logic for performing the steps of;
(1) transmitting the desired digital work from the remote server to the customer node;
(2) receiving the desired digital work; and
(3) storing the desired digital work on a memory of the customer node;
d. a remote server comprising;
i. memory;
ii. a processor connected to the memory of the remote server; and
iii. equipment connected to the processor of the remote server for coupling to the communications link which includes the public communications network;
iv. the digital works and identification data associated with each of the digital works stored on the memory of the remote server; and
v. logic for performing the steps of;
(1) receiving at the remote server a request to redeem the indicia;
(2) receiving at the remote server a distribution request, the distribution request comprising an identification of a desired digital work from the one or more digital works; and
(3) transmitting the desired digital work from the remote server to the customer node.

12. The system of claim 11, wherein the identification data of the desired digital work comprises a unique identifier.

13. The method of claim 12, wherein the desired digital work is associated with a unique identifier, and the unique identifier is stored in the remote server.

14. The system of claim 13, wherein the remote server is intermittently coupled to a merchant node used by the retail merchant, and wherein the remote server further comprises a status indicator indicating whether the indicia is available or not available for redemption, and the remote server further comprising logic for performing the steps of:
receiving a redemption request of the indicia, the redemption request specifying the unique indicia; and
setting at the remote server the status of the indicia as available for redemption.

15. The system of claim 11, wherein the indicia redeemable for one or more digital works stored on the remote server comprises a unique combination of an identifier and a password, and wherein the unique combination of the identifier and the password are disposed on a package.

16. The method of claim 15, wherein the password is a personal identification number (PIN).

17. The method of claim 15, wherein the password is obscured from view at the time of purchase.

18. The method of claim 11, wherein the remote server is intermittently coupled to the customer node over a public communications network.

19. The method of claim 18, wherein the public communications network comprises the Internet.

20. The system of claim 11, wherein the digital works comprise a song or other music file, a movie, television show, game, or other multimedia file, or a program or other software file.
